(19) United States
(12) Patent Application Publication
(10) Pub. No.: US 2023/0101205 A1
(43) Pub. Date: Mar. 30, 2023

(54) RECOMMENDATION CONTROL DEVICE, SYSTEM, METHOD, AND NON-TRANSITORY COMPUTER-READABLE MEDIUM STORING PROGRAM THEREIN

(71) Applicant: NEC Corporation, Minato-ku, Tokyo (JP)

(72) Inventor: Miki OTANI, Tokyo (JP)

(73) Assignee: NEC Corporation, Minato-ku, Tokyo (JP)

(21) Appl. No.: 17/802,013

(22) PCT Filed: Mar. 18, 2020
(86) PCT No.: PCT/JP2020/012101

§ 371 Date: Aug. 24, 2022

(51) Int. Cl. G06F 16/9535; G06F 21/32; G06F 21/31

(52) U.S. Cl. CPC G06F 16/9535; G06F 21/32; G06F 21/316

(57) ABSTRACT

A recommendation control device for providing recommendation information that suits an individual preference is provided. The recommendation control device (100) includes: an acquisition unit (130) that acquires a captured image being captured by a predetermined photographing device; an authentication control unit (140) that extracts a face area or face feature information from the captured image, and causes an authentication device (200) to perform face authentication; a behavior history extraction unit (150) that extracts a behavior history that satisfies a predetermined extraction condition from a behavior history of a user successful in the face authentication; an identification unit (160) that identifies recommendation information, based on a behavior history extracted by the behavior history extraction unit (150); and an output unit (170) that transmits recommendation information identified by the identification unit (160) to a predetermined display terminal.

### TECHNICAL FIELD

The present invention relates to a recommendation control device, a system, a method, and a non-transitory computer-readable medium that stores a program, and particularly relates to a recommendation control device, a system, a method, and a non-transitory computer-readable medium that stores a program, for providing recommendation information for a user.

### BACKGROUND ART

Patent Literature 1 discloses a technique of acquiring a face image of one person or two or more persons belonging to a group, acquiring a feature value needed for estimating an attribute (for example, distinction of sex and an age) of the person from the face image, and estimating the attribute for each person.

### CITATION LIST

### Patent Literature

[Patent Literature 1] Japanese Unexamined Patent Application Publication No. 2004-227158

### SUMMARY OF INVENTION

### Technical Problem

When recommendation information is generated by using all of individual behavior histories as in the technique disclosed in Patent Literature 1, there is a problem that recommendation accuracy may decrease. The reason is that a situation of a behavior history may be different depending on noise or a time zone.

The present disclosure has been made in order to solve such a problem, and an object of the present disclosure is to provide a recommendation control device, a system, a method, and a non-transitory computer-readable medium that stores a program, for providing recommendation information that suits an individual preference.

### Solution to Problem

A recommendation control device according to the present disclosure includes: an acquisition unit configured to acquire a captured image being captured by a predetermined photographing device; an authentication control unit configured to extract a face area or face feature information from the captured image, and cause an authentication device to perform face authentication; a behavior history extraction unit configured to extract a behavior history that satisfies a predetermined extraction condition from a behavior history of a user successful in the face authentication; an identification unit configured to identify recommendation information, based on a behavior history extracted by the behavior history extraction unit; and an output unit configured to transmit recommendation information identified by the identification means to a predetermined display terminal.

A recommendation control system according to the present disclosure includes: a predetermined photographing device configured to capture an image including a face area of a user; a recommendation control device configured to be communicable with the predetermined photographing device; and an authentication device configured to store face feature information about the user, and be communicable with the recommendation control device, wherein the recommendation control device includes an acquisition unit configured to acquire a captured image being captured by a predetermined photographing device, an authentication control unit configured to extract a face area or face feature information from the captured image, and cause an authentication device to perform face authentication, a behavior history extraction unit configured to extract a behavior history that satisfies a predetermined extraction condition from a behavior history of a user successful in the face authentication, an identification unit configured to identify recommendation information, based on a behavior history extracted by the behavior history extraction unit, and an output unit configured to transmit recommendation information identified by the identification unit to a predetermined display terminal.

A recommendation control method according to the present disclosure includes, by a computer: a step of acquiring a captured image being captured by a predetermined photographing device; a step of extracting a face area or face feature information from the captured image, and causing an authentication device to perform face authentication; a step of extracting a behavior history that satisfies a predetermined extraction condition from a behavior history of a user successful in the face authentication; a step of identifying recommendation information, based on the extracted behavior history; and a step of transmitting the identified recommendation information to a predetermined display terminal.

A non-transitory computer-readable medium according to the present disclosure records a program causing executing: a step of acquiring a captured image being captured by a predetermined photographing device; a step of extracting a face area or face feature information from the captured image, and causing an authentication device to perform face authentication; a step of extracting a behavior history that satisfies a predetermined extraction condition from a behavior history of a user successful in the face authentication; a step of identifying recommendation information, based on the extracted behavior history; and a step of transmitting the identified recommendation information to a predetermined display terminal.

A recommendation control device according to the present disclosure includes: an acquisition unit configured to acquire a captured image being captured by a predetermined photographing device; a face feature extraction unit configured to extract a face area or face feature information from the captured image; a face authentication unit configured to perform face authentication, based on the face area or the face feature information; a behavior history extraction unit configured to extract a behavior history that satisfies a predetermined extraction condition from a behavior history of a user successful in the face authentication; an identification unit configured to identify recommendation information, based on a behavior history extracted by the behavior history extraction unit; and an output unit configured to transmit recommendation information identified by the identification unit to a predetermined display terminal.

A recommendation control method according to the present disclosure includes, by a computer: a step of acquiring a captured image being captured by a predetermined photographing device; a step of extracting a face area or face feature information from the captured image; a step of performing face authentication, based on the face area or the face feature information; a step of extracting a behavior history that satisfies a predetermined extraction condition from a behavior history of a user successful in the face authentication; a step of identifying recommendation information, based on the extracted behavior history; and a step of transmitting the identified recommendation information to a predetermined display terminal.

A non-transitory computer-readable medium according to the present disclosure records a program causing executing: a step of acquiring a captured image being captured by a predetermined photographing device; a step of extracting a face area or face feature information from the captured image; a step of performing face authentication, based on the face area or the face feature information; a step of extracting a behavior history that satisfies a predetermined extraction condition from a behavior history of a user successful in the face authentication; a step of identifying recommendation information, based on the extracted behavior history; and a step of transmitting the identified recommendation information to a predetermined display terminal.

### Advantageous Effects of Invention

The present disclosure is able to provide a recommendation control device, a system, a method, and a non-transitory computer-readable medium that stores a program, for providing recommendation information that suits an individual preference.

### BRIEF DESCRIPTION OF DRAWINGS

FIG. 1 is a block diagram illustrating a configuration of a recommendation control device according to a first example embodiment;

FIG. 2 is a flowchart illustrating a flow of a recommendation control method according to the first example embodiment;

FIG. 3 is a block diagram illustrating a configuration of a recommendation control system according to a second example embodiment;

FIG. 4 is a block diagram illustrating a configuration of an authentication device;

FIG. 5 is a block diagram illustrating a configuration of a face authentication terminal;

FIG. 6 is a block diagram illustrating a configuration of a user terminal;

FIG. 7 is a flowchart illustrating a flow of face feature information registration processing;

FIG. 8 is a flowchart illustrating a flow of face authentication processing;

FIG. 9 is a flowchart illustrating a flow of history registration processing;

FIG. 10 is a flowchart illustrating a flow of the history registration processing;

FIG. 11 is a flowchart illustrating a flow of recommendation control processing;

FIG. 12 is a flowchart illustrating a flow of recommendation request processing;

FIG. 13 is a diagram illustrating a recommendation request start screen displayed on an operation terminal;

FIG. 14 is a diagram illustrating a recommendation information screen displayed on a display terminal;

FIG. 15 is a diagram illustrating a map displayed on the display terminal;

FIG. 16 is a diagram illustrating a behavior history displayed on the display terminal;

FIG. 17 is a diagram illustrating a history exclusion condition setting screen displayed on the display terminal;

FIG. 18 is a diagram illustrating a history registration screen displayed on the operation terminal during settlement;

FIG. 19 is a block diagram illustrating a configuration of a recommendation control device according to a third example embodiment;

FIG. 20 is a diagram illustrating a history setting screen displayed on an operation terminal;

FIG. 21 is a diagram illustrating a history classification screen displayed on the operation terminal;

FIG. 22 is a block diagram illustrating a configuration of a recommendation control device according to a fourth example embodiment; and

FIG. 23 is a block diagram illustrating a configuration of a recommendation control system according to the fourth example embodiment.

### EXAMPLE EMBODIMENT

Hereinafter, example embodiments of the present disclosure will be described in detail with reference to drawings. In each of the drawings, the same or corresponding elements will be denoted by the same reference signs, and duplicate description will be omitted depending on need for the sake of clarity of explanation.

### First Example Embodiment

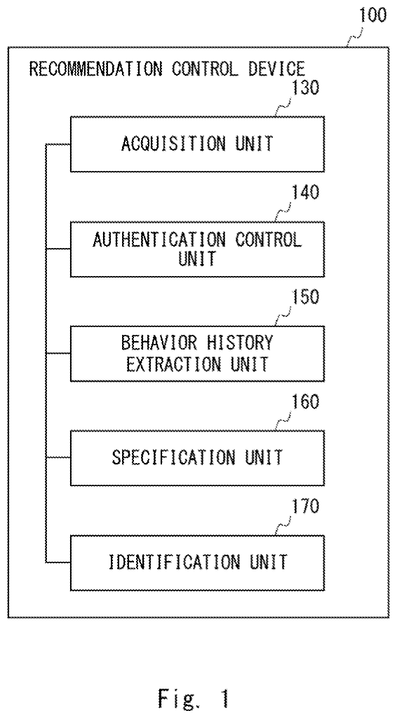

FIG. 1 is a block diagram illustrating a configuration of a recommendation control device 100 according to a first example embodiment. The recommendation control device 100 includes an acquisition unit 130, an authentication control unit 140, a behavior history extraction unit 150, an identification unit 160, and an output unit 170. The recommendation control device 100 is connected to a network 500 (not illustrated). The network 500 may be wired or may be wireless. An authentication device 200 and a face authentication terminal 300 that are not illustrated are connected to the network 500.

The acquisition unit 130 acquires a captured image being captured by a predetermined photographing device. The captured image is an image in which a user is captured. The predetermined photographing device is, for example, a camera included in the face authentication terminal 300, and a camera of a user terminal such as a smartphone possessed by a user. The authentication control unit 140 extracts a face area or face feature information from a captured image, and causes the authentication device 200 to perform face authentication. The authentication device 200 stores, in advance, a user ID and face feature information about the user in association with each other.

The behavior history extraction unit 150 extracts a behavior history that satisfies a predetermined extraction condition from behavior histories of a user successful in face authentication. The behavior history is a content of behavior performed by a user. The behavior history may include a date and time, a place, and the like in which the behavior is performed. The behavior history includes, for example, a settlement history of a user. The predetermined extraction condition is a condition for extracting a predetermined behavior history from behavior histories of a user. The predetermined extraction condition includes, for example, a specific settlement history. Specific examples of the predetermined extraction condition include a time zone, a predetermined period, a frequency of behavior, and the like, which are not limited thereto.

The identification unit 160 identifies recommendation information to be recommended to a user, based on a behavior history associated with a user ID of a user successful in face authentication or a user ID included in a recommendation request. The recommendation request is a presentation request of recommendation information. The output unit 170 transmits recommendation information identified by the identification unit 160 to a predetermined display terminal. The predetermined display terminal is, for example, the face authentication terminal 300, a user terminal, a store terminal, or signage on a street. The user terminal is, for example, a communication terminal such as a smartphone possessed by a user. The store terminal is a terminal installed at each store, and, for example, displays a recommended product when a user comes to a store, and displays “How about going to XX next?” and the like when a user leaves a store.

The predetermined display terminal may be the predetermined photographing device described above, or may be a different terminal. For example, when a captured image is captured by the user terminal, the output unit 170 may transmit recommendation information to the user terminal, or may transmit recommendation information to the face authentication terminal 300 or the like. When a captured image is captured by the face authentication terminal 300, the output unit 170 may transmit recommendation information to the face authentication terminal 300, or may transmit recommendation information to the user terminal or the like.

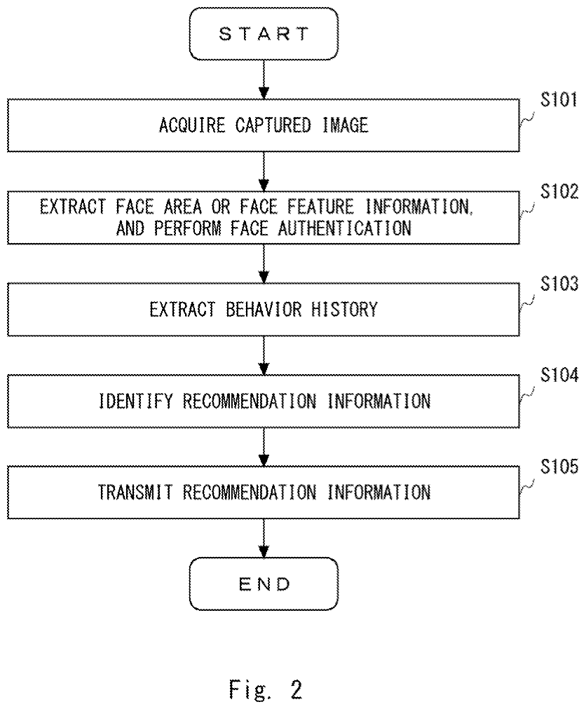

FIG. 2 is a flowchart illustrating a flow of a recommendation control method according to the first example embodiment. First, the acquisition unit 130 acquires a captured image being captured by a predetermined photographing device (step S101). Next, the authentication control unit 140 extracts a face area or face feature information from the captured image acquired by the acquisition unit 130, and causes the authentication device 200 to perform face authentication (step S102). The authentication device 200 verifies the face area or the face feature information received from the authentication control unit 140 with face feature information registered in the authentication device 200, determines whether the authentication is successful by presence or absence of coincidence, and returns a determination result. Note that it is assumed that the authentication device 200 stores a user ID and face feature information in association with each other. Then, when the face authentication is successful, the authentication device 200 returns a determination result including the user ID successful in the face authentication.

Next, the behavior history extraction unit 150 extracts a behavior history that satisfies a predetermined extraction condition (step S103). Next, the identification unit 160 identifies recommendation information to be recommended to a user, based on a behavior history associated with the user ID successful in the face authentication or a user ID included in a recommendation request (step S104). Next, the output unit 170 transmits the recommendation information identified by the identification unit 160 to a predetermined display terminal (step S105). In this way, the recommendation control method according to the present example embodiment can provide recommendation information that suits an individual preference.

The recommendation control device 100 may include each configuration such as a history storage unit and a history registration unit in addition to the configuration illustrated in FIG. 1.

The history storage unit stores a behavior history of a user. The behavior history is a history of a behavior content performed by a user when face authentication is successful, and is, for example, a purchase history of a product and the like, an enter/exit history of a facility, a participation history of an event, and the like. The behavior history may include information about a time at which a user performs behavior. The history registration unit registers a user ID and a behavior history in association with each other in the history storage unit. The history registration unit registers a user ID and a behavior history in association with each other in the history storage unit before step S101 illustrated in FIG. 2.

Note that the recommendation control device 100 includes a processor, a memory, and a storage device as a configuration that is not illustrated. Further, the storage device stores a computer program in which processing of the recommendation control method according to the present example embodiment is implemented. Then, the processor loads the computer program from the storage device into the memory, and executes the computer program. In this way, the processor achieves a function of the history registration unit, the acquisition unit 130, the authentication control unit 140, the behavior history extraction unit 150, the identification unit 160, and the output unit 170.

Alternatively, the history registration unit, the acquisition unit 130, the authentication control unit 140, the behavior history extraction unit 150, the identification unit 160, and the output unit 170 may each be achieved by dedicated hardware. Further, a part or the whole of each of the components of each of the devices may be achieved by general-purpose or dedicated circuitry, processor, and the like, or achieved by a combination thereof. A part or the whole of each of the components may be formed by a single chip or formed by a plurality of chips connected to one another via a bus. A part or the whole of each of the components of each of the devices may be achieved by a combination of the above-described circuitry and the like and a program. Further, as the processor, a central processing unit (CPU), a graphics processing unit (GPU), a field-programmable gate array (FPGA), or the like can be used.

Further, when a part or the whole of each of the components of the recommendation control device 100 is achieved by a plurality of information processing devices, circuitry, or the like, the plurality of information processing devices, the circuitry, or the like may be arranged in a centralized manner or a distributed manner. For example, the information processing devices, the circuitry, and the like may be achieved as a form in which those are connected with each other via a communication network, such as a client server system and a cloud computing system. Further, the function of the recommendation control device 100 may be provided in a SaaS (Software as a Service) form.

### Second Example Embodiment

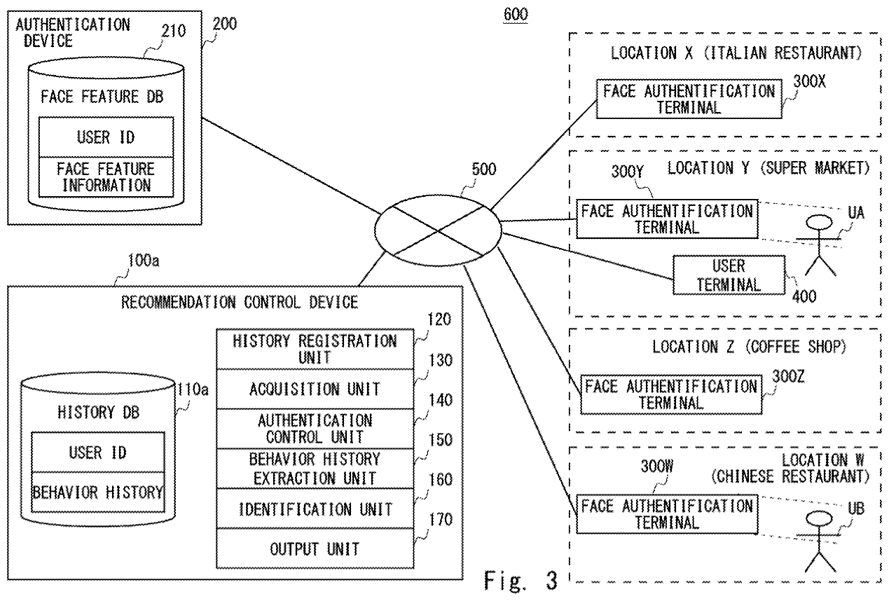

A second example embodiment is a specific example of the first example embodiment described above. FIG. 3 is a block diagram illustrating a configuration of a recommendation control system 600 according to the second example embodiment. The recommendation control system 600 includes at least a recommendation control device 100a and an authentication device 200, and further includes at least one of a face authentication terminal 300 and a user terminal 400. Each of the recommendation control device 100a, the authentication device 200, the face authentication terminal 300 (300X, 300Y, 300Z, and 300W), and the user terminal 400 is connected to one another via a network 500. Note that description overlapping the first example embodiment will be appropriately omitted.

The recommendation control device 100a includes a history database (DB) 110a, a history registration unit 120, an acquisition unit 130, an authentication control unit 140, a behavior history extraction unit 150, an identification unit 160, and an output unit 170. The recommendation control device 100a is an information processing device that accumulates a behavior history and identifies and presents presentation information from a captured image, and is, for example, a server device achieved by a computer.

The history DB 110a is a database for accumulating a behavior history of a user. The history DB 110a stores a user ID and a behavior history of the user in association with each other. The behavior history includes, for example, a settlement history of a user. The history registration unit 120 receives a history registration request from the face authentication terminal 300 or the user terminal 400 via the network 500, and registers, in association with each other in the history DB 110a, a user ID included in the history registration request, and a behavior history.

The acquisition unit 130 receives a face authentication request, a history registration request, and a recommendation request from the face authentication terminal 300 or the user terminal 400 via the network 500. In other words, the acquisition unit 130 acquires a captured image by a camera 310 or 410, installation position information (hereinafter simply referred to as an “installation position”) of the camera 310 or 410, and the like from the face authentication terminal 300 or the user terminal 400.

The authentication control unit 140 extracts a face area or face feature information from an authentication image included in a face authentication request, transmits the face area or the face feature information to the authentication device 200, and causes the authentication device 200 to perform face authentication. Further, the authentication control unit 140 receives success or failure of the face authentication from the authentication device 200, and returns a face authentication result to a terminal being a request source. Note that, when the face authentication is successful, a user ID is included in a face authentication result.

The behavior history extraction unit 150 acquires, from the history DB 110a, a behavior history associated with a user ID successful in the face authentication or a user ID included in a recommendation request. The behavior history extraction unit 150 extracts a behavior history that satisfies a predetermined extraction condition from among behavior histories acquired from the history DB 110a. The behavior history extraction unit 150 extracts a behavior history that satisfies a predetermined extraction condition, and thus noise of the behavior history can be removed. Note that the predetermined extraction condition may be, for example, included in a recommendation request or preset. Further, the predetermined extraction condition may be manually changeable by a user.

The predetermined extraction condition may be appropriately selected from among a plurality of extraction conditions being preset, for example. For example, the predetermined extraction condition may be selected based on a date and time at which the face authentication is performed, information included in a captured image, or the like. Specifically, when a date and time at which the face authentication is successful is daytime on a weekday, it is conceivable to select an extraction condition for extracting a behavior history performed during daytime on a weekday, and the like. Further, when a family of a user is captured in a captured image, it is conceivable to select an extraction condition for extracting a behavior history in which the user takes action with the family, and the like.

When the behavior history includes a settlement history, the predetermined extraction condition may further include a predetermined time zone in which settlement is performed. The predetermined time zone is, for example, a weekend, a weekday, lunch time, dinner time, and the like. In this case, the behavior history extraction unit 150 extracts a settlement history in which the user performs settlement in the predetermined time zone from among a plurality of settlement histories included in the behavior histories.

When the behavior history includes a settlement history, the predetermined extraction condition may further include a predetermined period in which settlement is performed. The predetermined period is, for example, after a specific date and time, before a specific date and time, a specific period, and the like. In this case, the behavior history extraction unit 150 extracts a settlement history in which the user performs settlement in the predetermined period from among a plurality of settlement histories included in the behavior histories.

When the behavior history includes a settlement history, the predetermined extraction condition may further include, as a condition, settlement being performed for a reference number of times or more in a predetermined period. For example, settlement being performed for three times or more within latest two months may be set as a condition. In this case, the behavior history extraction unit 150 extracts a settlement history in which the user performs settlement for the reference number of times or more in the predetermined period from among a plurality of settlement histories included in the behavior histories.

Further, the behavior history extraction unit 150 may acquire, from the history DB 110a, a behavior history of another person having at least one of an attribute and a behavior history similar to a user. In this case, the behavior history extraction unit 150 extracts a behavior history that satisfies a predetermined extraction condition from among behavior histories of the another person being acquired from the history DB 110a. The attribute may be, for example, a gender, an age, a family structure, or the like, and may be a friend on a social networking service (SNS), or the like. The another person having a similar behavior history is, for example, another person including, in a behavior history, the same character string as that of a predetermined behavior included in a behavior history of the user.

The identification unit 160 identifies recommendation information, based on a behavior history extracted by the behavior history extraction unit 150. The recommendation information is information to be recommended to a user. The recommendation information may be, for example, a behavior history itself being extracted by the behavior history extraction unit 150. The recommendation information may include, for example, one of a place and a content included in an extracted behavior history. Further, the recommendation information may be a discount coupon of a place included in an extracted behavior history, or the like. The output unit 170 transmits, via the network 500, presentation information identified by the identification unit 160 to a terminal successful in the face authentication or a terminal that makes a presentation request. The output unit 170 may transmit the recommendation information to a terminal other than the terminal that performs the face authentication and the recommendation request. For example, when the face authentication is performed from a store terminal, the output unit 170 may transmit recommendation information to the store terminal, or may transmit recommendation information to a user terminal possessed by a user successful in the face authentication.

The authentication device 200 is a device that performs the face authentication of a user. The authentication device 200 includes a face feature DB 210. The face feature DB 210 is a database that stores a user ID and face feature information about the user in association with each other. Note that the face feature DB 210 is one example of a face feature information storage unit. The face authentication terminal 300 is a terminal that captures an image used for the face authentication. The face authentication terminal 300 is a terminal that transmits a captured image to the recommendation control device 100a, and makes a face authentication request. The face authentication terminal 300 is installed at each of points X, Y, Z, and W (hereinafter referred to as “points X to W”). Specifically, the face authentication terminal 300X is installed at the point X, the face authentication terminal 300Y is installed at the point Y, the face authentication terminal 300Z is installed at the point Z, and the face authentication terminal 300W is installed at the point W. When a user visits each of the points X to W, the user faces a camera of the installed face authentication terminals 300X to 300W, performs capturing, and performs purchase of a product at the point and the like.

The user terminal 400 is a terminal possessed by a user. The user terminal 400 is a communication terminal such as, for example, a smartphone, a tablet terminal, and a PC. A user uses the face authentication terminal 300 or the user terminal 400, and captures an image including a face of the user. The face authentication terminal 300 or the user terminal 400 transmits a captured image to the recommendation control device 100a.

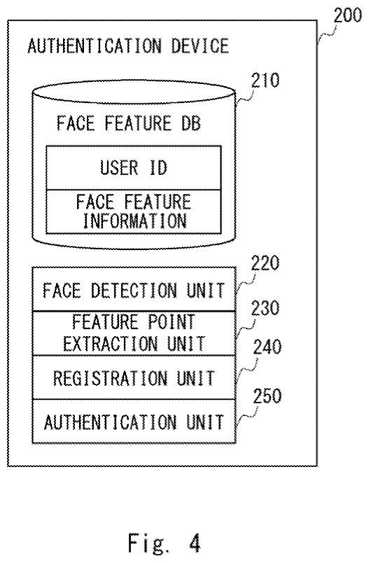

Next, a configuration of the authentication device 200 will be described in detail with reference to FIG. 4. FIG. 4 is a block diagram illustrating the configuration of the authentication device 200. The authentication device 200 includes the face feature DB 210, a face detection unit 220, a feature point extraction unit 230, a registration unit 240, and an authentication unit 250.

The face feature DB 210 is a face feature database that stores a user ID and face feature information about the user in association with each other. The face detection unit 220 detects a face area included in a captured image, and outputs the face area to the feature point extraction unit 230. The feature point extraction unit 230 extracts a feature point from the face area detected by the face detection unit 220, and outputs face feature information to the registration unit 240. The face feature information is a group of extracted feature points.

The registration unit 240 newly issues a user ID at a time of registration of face feature information. The registration unit 240 registers, in the face feature DB 210, the issued user ID and the face feature information extracted from the registration image in association with each other. The authentication unit 250 verifies the face feature information extracted from the face image with the face feature information in the face feature DB 210. The authentication unit 250 determines that the face authentication is successful when the pieces of face feature information coincide with each other, and determines that the face authentication fails when the pieces of face feature information do not coincide with each other. The authentication unit 250 returns success or failure of the face authentication to the recommendation control device 100a. Presence or absence of coincidence of the face feature information is associated with success or failure of the authentication. Further, the authentication unit 250 identifies a user ID associated with face feature information successful in the face authentication when the face authentication is successful, and returns an authentication result including the identified user ID and authentication success to the recommendation control device 100a.

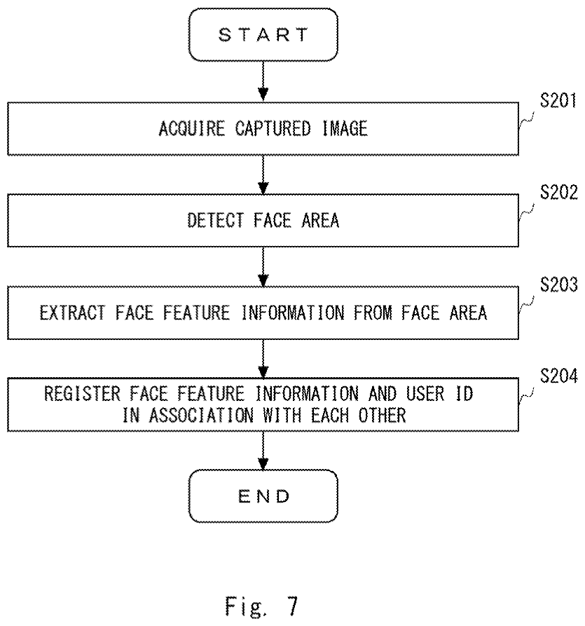

An operation of the authentication device 200 when the authentication device 200 registers a user ID and face feature information in the face feature DB 210 will be described with reference to FIG. 7. FIG. 7 is a flowchart illustrating a flow of face feature information registration processing. In FIG. 7, a case where the face authentication terminal 300 captures an image and registers face feature information is described, but face feature information can also be registered by a similar procedure when the user terminal 400 captures an image.

When the face feature information is registered, the face authentication terminal 300 captures an image including a face of a user as a registration image, and makes a face feature information registration request from the authentication device 200 via the network 500. The face feature information registration request includes the registration image. First, the authentication device 200 acquires a registration image from the face authentication terminal 300 or the user terminal 400 via the network 500 (step S201).

Next, the face detection unit 220 detects a face area included in the registration image (step S202), and outputs the detected face area to the feature point extraction unit 230. Next, the feature point extraction unit 230 extracts a feature point from the face area, and outputs face feature information to the registration unit 240 (step S203). Next, the registration unit 240 issues a user ID associated with the output face feature information, and registers the user ID and the face feature information in association with each other in the face feature DB 210 (step S204).

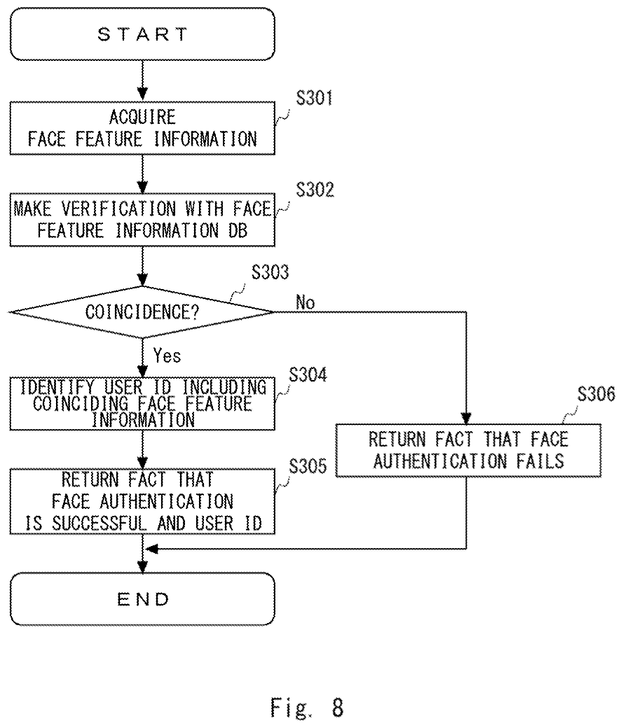

An operation of the authentication device 200 when the face authentication is performed will be described with reference to FIG. 8. FIG. 8 is a flowchart illustrating a flow of face authentication processing. In FIG. 8, a case where the face authentication terminal 300 makes a face authentication request is described, but the face authentication can also be performed by a similar procedure when the user terminal 400 makes a face authentication request.

When the face authentication is performed, the face authentication terminal 300 captures an image including a face of a user as an authentication image, and makes a face authentication request from the recommendation control device 100a via the network 500. The face authentication request includes the authentication image. First, the recommendation control device 100a transmits a face area or face feature information being extracted from an authentication image to the authentication device 200. The feature point extraction unit 230 extracts the face feature information from the received face area or receives the face feature information, and thus acquires the face feature information (step S301).

Next, the authentication unit 250 verifies the face feature information acquired by the acquisition unit 130 with the face feature DB 210 (step S302). When the face feature information coincides (step S303: Yes), the authentication unit 250 identifies a user ID of a user whose face feature information coincides (step S304), and returns a fact that the face authentication is successful and the identified user ID to the recommendation control device 100a (step S305). When there is no coinciding face feature information (step S303: No), the authentication unit 250 returns a fact that the face authentication fails to the recommendation control device 100a (step S306).

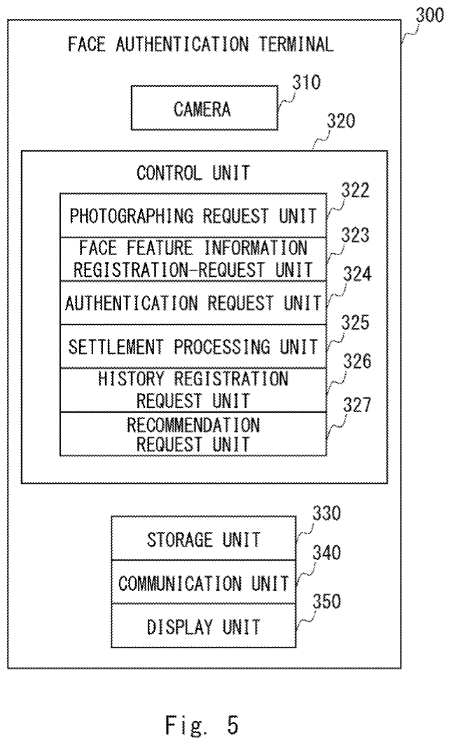

Next, a configuration of the face authentication terminal 300 will be described in detail with reference to FIG. 5. The face authentication terminal 300 includes, as a hardware configuration, a photographing device such as a camera, a display device, and a computer. The face authentication terminal 300 is a device that makes a face feature information registration request and a face authentication request. Examples of the face authentication terminal 300 include, for example, a terminal that performs settlement by face authentication, a terminal that performs entry control by face authentication, digital signage that presents information according to face authentication, and the like, which are not limited thereto.

FIG. 5 is a block diagram illustrating the configuration of the face authentication terminal 300. The face authentication terminal 300 includes the camera 310, a control unit 320, a storage unit 330, a communication unit 340, and a display unit 350. The camera 310 is a photographing device that captures an image. The control unit 320 performs control of the hardware included in the face authentication terminal 300. The control unit 320 includes a photographing request unit 322, a face feature information registration-request unit 323, an authentication request unit 324, a settlement processing unit 325, a history registration request unit 326, and a recommendation request unit 427.

The photographing request unit 322 makes a photographing request from the camera 310. The camera 310 captures an image including a face of a user. The image captured by the camera 310 is used as a registration image and an authentication image. The face feature information registration-request unit 323 transmits a face feature information registration request to the authentication device 200 via the network 500. The face feature information registration request includes the registration image captured by the camera 310. The authentication request unit 324 transmits a face authentication request to the recommendation control device 100a via the network 500. The face authentication request includes the authentication image captured by the camera 310. The authentication request unit 324 receives success or failure of the face authentication from the recommendation control device 100a, and displays the result on the display unit 350.

The settlement processing unit 325 performs settlement processing when the face authentication is successful. Note that the control unit 320 may include a recording unit that is not illustrated instead of the settlement processing unit 325. The recording unit records entering and exiting of a user to and from a facility in which the face authentication terminal 300 is installed when the face authentication is successful. The history registration request unit 326 transmits a history registration request to the recommendation control device 100a via the network 500. Note that the history registration request includes a settlement history being a result of the settlement processing. The settlement history is, for example, information including a date and time at which settlement is performed, a price, an article, a user ID, and the like. The recommendation request unit 327 transmits a recommendation information request to the recommendation control device 100a via the network 500.

The storage unit 330 is a storage device that stores a program for achieving each function of the face authentication terminal 300. The communication unit 340 is a communication interface with the network 500. The display unit 350 is a display device that displays a face authentication result, presentation information, and the like for a user.

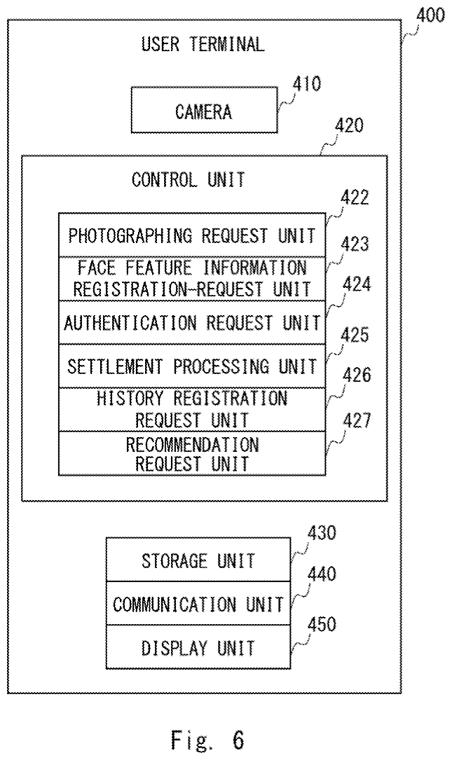

Next, a configuration of the user terminal 400 will be described in detail with reference to FIG. 6. FIG. 6 is a block diagram illustrating the configuration of the user terminal 400. The user terminal 400 includes the camera 410, a control unit 420, a storage unit 430, a communication unit 440, and a display unit 450. The control unit 420 includes a photographing request unit 422, a face feature information registration-request unit 423, an authentication request unit 424, a settlement processing unit 425, a history registration request unit 426, and a recommendation request unit 427. Since a function of each of the configurations included in the user terminal 400 is similar to each of the configurations included in the face authentication terminal 300, description will be omitted.

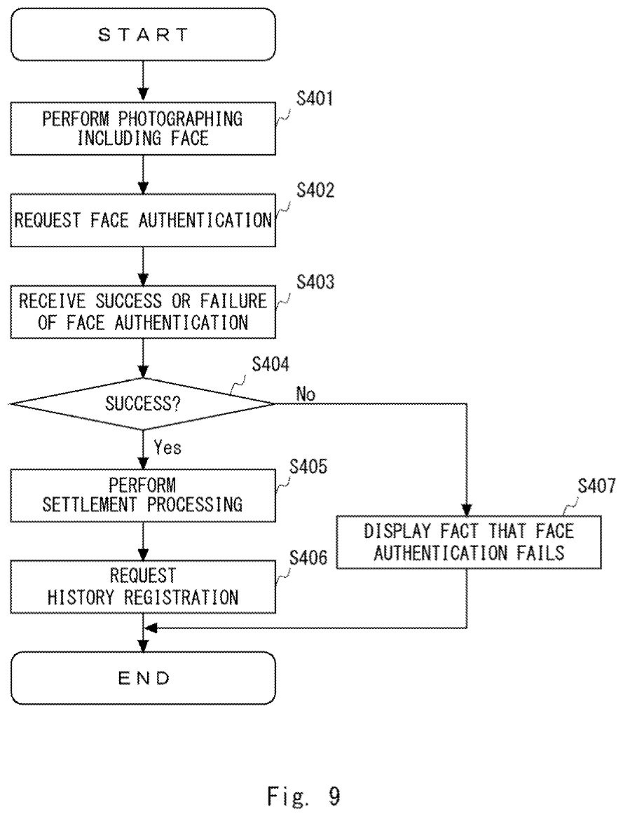

The face authentication terminal 300 and the user terminal 400 perform the settlement processing and the like when the face authentication is successful, and make a history registration request to register a history thereof in the recommendation control device 100a. Hereinafter, an operation of the face authentication terminal 300 when a history registration request is made will be described with reference to FIG. 9. FIG. 9 is a flowchart illustrating a flow of history registration processing. In FIG. 9, a case where the face authentication terminal 300 makes a history registration request is described, but the user terminal 400 can also make a history registration request by a similar procedure.

First, the photographing request unit 322 makes a photographing request from the camera 310, and the camera 310 captures an authentication image including a face of a user (step S401). Next, the authentication request unit 324 transmits a face authentication request to the authentication device 200 via the network 500 (step S402), and receives success or failure thereof from the authentication device 200 (step S403). When the face authentication is successful (step S404: Yes), the settlement processing unit 325 performs settlement processing (step S405), and the history registration request unit 326 makes a history registration request from the recommendation control device 100a via the network 500 (step S406). When the face authentication fails (step S405: No), the history registration request unit 326 displays a fact that the face authentication fails on the display unit 350.

Note that, in FIG. 9, a case where the settlement processing is performed when the face authentication is successful is described, but processing of recording an enter/exit history, recording a participation history, and the like may be performed when the face authentication is successful. The face authentication terminal 300 and the user terminal 400 make, from the recommendation control device 100a, a registration request for a behavior history such as the enter/exit history and the participation history similarly to a settlement history. Further, when the face authentication is successful, a user may stand in front of signage including a camera before and after settlement and the like, and may capture a captured image including a face.

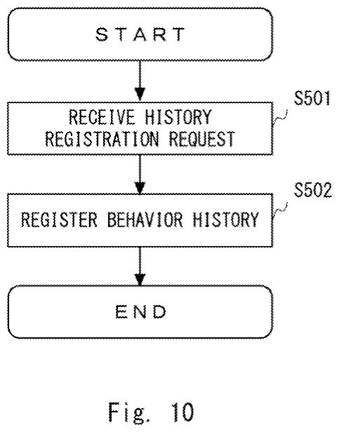

FIG. 10 is a flowchart illustrating a flow of history registration processing. The history registration request transmitted in step S405 described above includes a behavior history. When the recommendation control device 100a receives the history registration request (step S501), the recommendation control device 100a registers the behavior history in the history DB 110a (step S502).

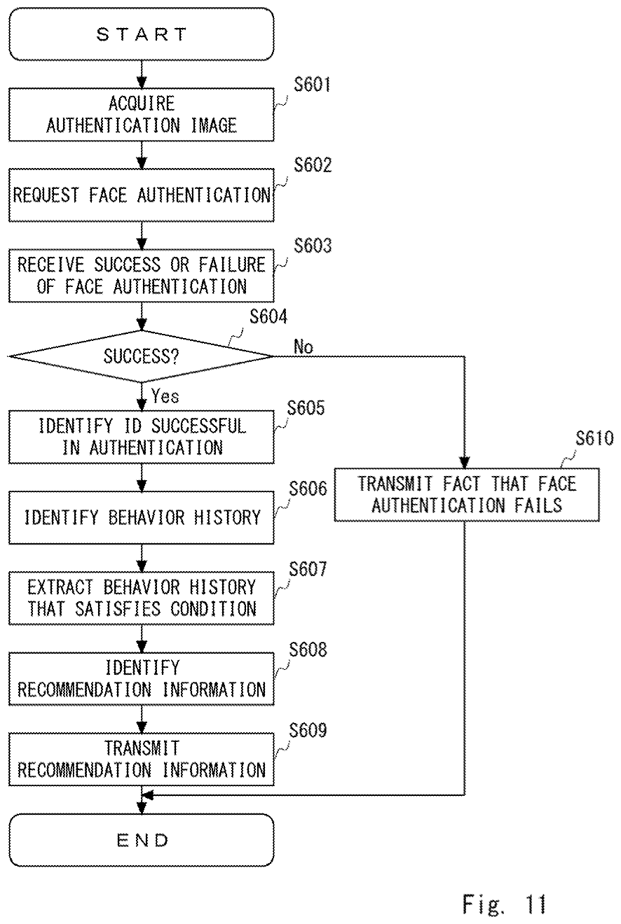

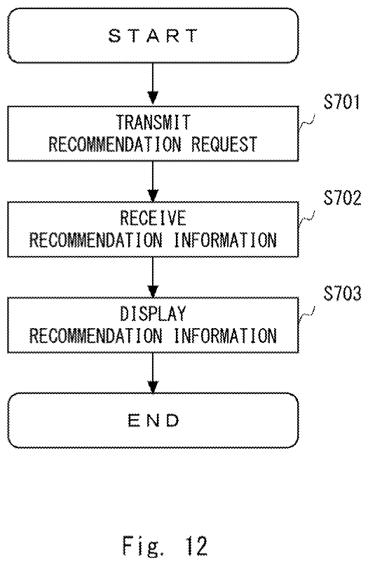

The recommendation control device 100a presents recommendation information when the face authentication is successful or when a recommendation information request is received. Examples of presenting recommendation information when the face authentication is successful include a case where a user stands in front of signage including a camera before and after settlement and the like, and captures a captured image including a face, and a case where processing of recording an enter/exit history, recording a participation history, and the like is performed. The recommendation information is displayed on signage, the user terminal 400, and the like. Hereinafter, an operation of the recommendation control device 100a and the like when recommendation information is presented will be described with reference to FIGS. 11 to 12. FIG. 11 is a flowchart illustrating a flow of recommendation control processing. FIG. 12 is a flowchart illustrating a flow of recommendation request processing.

First, a case where recommendation information is presented when the face authentication is successful will be described with reference to FIG. 11. First, the acquisition unit 130 acquires an authentication image being captured by a predetermined photographing device such as the face authentication terminal 300 and the user terminal 400 (step S601). Note that it is assumed that the acquisition unit 130 acquires an installation position of the predetermined photographing device together with the authentication information at this time. Next, the authentication control unit 140 extracts a face area or face feature information, transmits the face area or the face feature information to the authentication device 200, and requests the face authentication (step S602). Next, the authentication control unit 140 receives success or failure of the face authentication from the authentication device 200 (step S603).

When the face authentication is successful (step S604: Yes), the identification unit 160 identifies a user ID successful in the face authentication by extracting the user ID included in success or failure of the face authentication being received in step S603 (step S605). Next, the behavior history extraction unit 150 identifies a behavior history of a user by acquiring, from the history DB 110a, the behavior history associated with the user ID being identified in step S605 (step S606).

Next, the behavior history extraction unit 150 extracts a behavior history that satisfies a predetermined extraction condition from the behavior histories of the user (step S607). For example, the predetermined extraction condition is preset and includes a time zone. Specifically, the predetermined extraction condition is, for example, a history of stores visited by the user on weekdays. The user often visits a restaurant near a workplace on weekdays, i.e., working days, and often visits a restaurant near home on a weekend. Thus, when a visit by the user on weekdays is set as the predetermined extraction condition, a restaurant near a workplace being often visited by the user can be extracted.

Next, the identification unit 160 identifies recommendation information, based on the behavior history extracted by the behavior history extraction unit 150 (step S608). Next, the output unit 170 transmits the recommendation information identified by the identification unit 160 to a predetermined display terminal such as the face authentication terminal 300 and the user terminal 400 via the network 500 (step S609). When the face authentication fails (step S604: No), the output unit 170 transmits a fact that the face authentication fails to the predetermined display terminal via the network 500 (step S610).

Next, a case where recommendation information is presented in response to a recommendation request will be described with reference to FIG. 12. When the face authentication is successful (step S404: Yes), the face authentication terminal 300 and the user terminal 400 can perform the recommendation request processing (steps S701 to S703). The recommendation request processing (steps S701 to S703) may be performed simultaneously with the settlement processing (step S405) and the history registration request (step S406), or may be performed after the history registration request (step S406). In FIG. 12, a case where the face authentication terminal 300 performs the recommendation request processing is described, but the user terminal 400 can also perform the recommendation request processing by a similar procedure.

First, the recommendation request unit 327 transmits a recommendation request to the recommendation control device 100a via the network 500 (step S701). When the recommendation control device 100a receives the recommendation request, the recommendation control device 100a identifies and returns recommendation information by a procedure similar to that in steps S605 to S609. When the recommendation request unit 327 receives the recommendation information from the recommendation control device 100a (step S702), the recommendation request unit 327 displays the recommendation information on the display unit 350 (step S703).

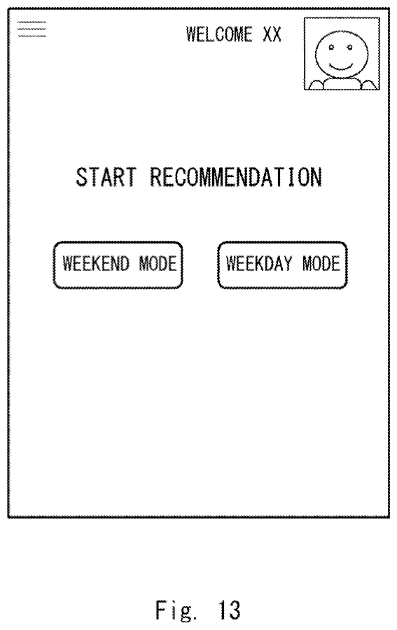

In step S701, a user transmits a recommendation request to the recommendation control device 100a by operating an operation terminal such as the face authentication terminal 300 and the user terminal 400. The operation terminal may be the same terminal as a display terminal to which recommendation information is transmitted, or may be a different terminal. FIG. 13 is a diagram illustrating a recommendation request start screen displayed on an operation terminal. FIG. 13 illustrates a case where a recommendation request is made by operating the user terminal 400. As illustrated in FIG. 13, the user terminal 400 can display the recommendation request (recommendation) start screen.

When a user starts a recommendation request by operating the user terminal 400, the user may manually set an extraction condition by selecting a mode. For example, as illustrated in FIG. 13, when buttons for selecting “weekend mode” and “weekday mode” are displayed on the recommendation request start screen, the user presses either of the buttons and starts the recommendation request. For example, when the user presses the “weekend mode” button, the user terminal 400 sets a “behavior history of the user on a weekend” as a predetermined extraction condition, and transmits a recommendation request including the predetermined extraction condition to the recommendation control device 100a. In this way, the user can manually set a predetermined extraction condition by selecting a mode during a recommendation request.

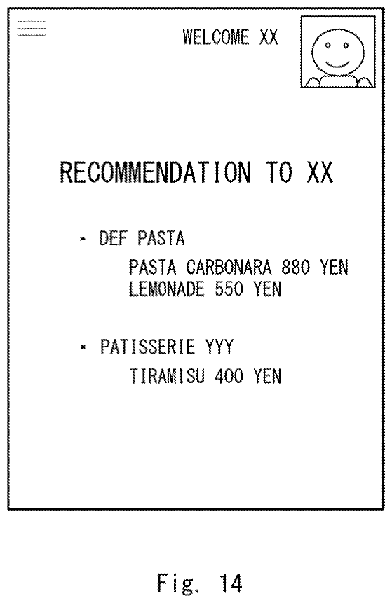

FIG. 14 is a diagram illustrating recommendation information displayed on a display terminal. FIG. 14 illustrates a case where the recommendation information is displayed on the user terminal 400. As illustrated in FIG. 14, the user terminal 400 displays the recommendation information received in step S609 on a screen. Note that, for example, when the recommendation information includes store information, detailed information about a store, map information, route information to the store, and the like can be displayed on the screen illustrated in FIG. 14. Further, in step S609, the output unit 170 may transmit a behavior history of a user in addition to the recommendation information to the user terminal 400.

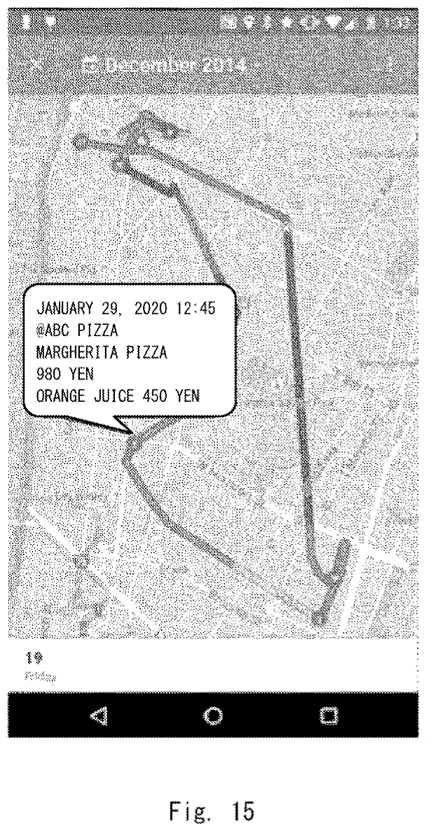

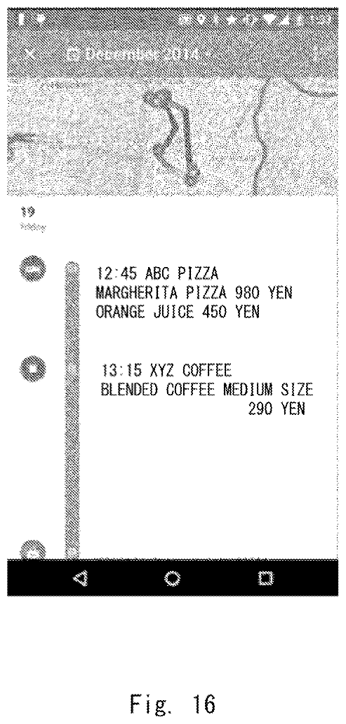

FIG. 15 is a diagram illustrating a map displayed as a behavior history on the display terminal. As illustrated in FIG. 15, the user terminal 400 may display a behavior history of a user received in step S609 on the map. FIG. 16 is a diagram illustrating a behavior history displayed on the display terminal. As illustrated in FIG. 16, the user terminal 400 may display the behavior history received in step S609 in time series.

FIGS. 15 and 16 illustrate a case where only a behavior history of a first user is displayed on the display terminal, but may display recommendation information in addition to the behavior history on the display terminal. The recommendation information may include store information, an address of a store, a route guide from a current position of a user to the store, and the like. The route guide may include a distance from the current position of the user to the store, time required, and the like. Further, a plurality of pieces of recommendation information may be displayed on the display terminal. When a plurality of pieces of recommendation information are displayed, details, a route guide, and the like of each of the pieces of recommendation information may be simultaneously displayed. A user can consider the details, the route guide, and the like of each of the pieces of recommendation information, and compare the pieces of recommendation information.

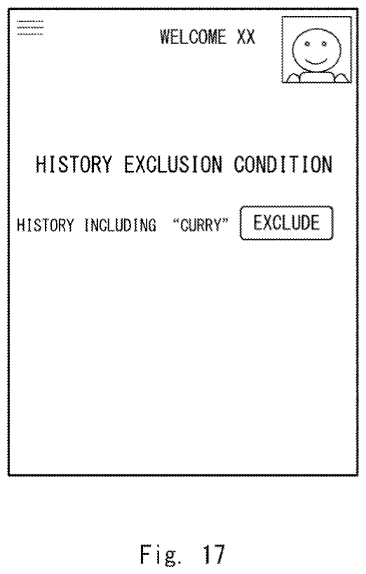

A user may manually exclude a specific behavior history from his/her own behavior history. A user excludes a specific behavior history by operating an operation terminal such as the user terminal 400. The specific behavior history is, for example, settlement information including a specific character string. FIG. 17 is a diagram illustrating a history exclusion condition setting screen displayed on the display terminal. A user can specify exclusion of a specific behavior history from the history exclusion condition setting screen displayed on the display terminal. As illustrated in FIG. 17, for example, the user inputs a character string “curry”, and can specify exclusion of a behavior history including the character string “curry”. The operation terminal transmits, to the recommendation control device 100a via the network 500, the specification for excluding the specific behavior history being received from the user. When the behavior history extraction unit 150 receives the specification, the behavior history extraction unit 150 adds the condition for excluding the specified specific behavior history to a predetermined extraction condition.

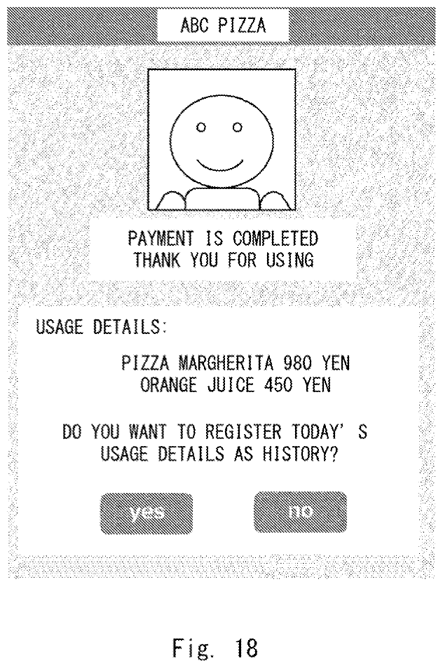

Further, only a behavior history desired to be registered by a user may be registered in the history DB 110a. For example, only a settlement history desired to be registered by a user during settlement may be registered in the history DB 110a. FIG. 18 is a diagram illustrating a history registration screen displayed on the operation terminal during settlement. A user operates the operation terminal such as the user terminal, and specifies a desire for registration. As illustrated in FIG. 18, the user is caused to select whether to register a settlement history during settlement.

Hereinafter, a specific example of recommendation information presented to a user will be described. For example, it is assumed that a predetermined extraction condition is a “settlement history of a user on weekdays”. The settlement history of the user is illustrated in Table 1 below.

TABLE 1

| | | | |
|---|---|---|---|
| DATE | 2019 Apr. 1(MON) | 2019 Apr. 6(SAT) | 2019 Apr. 9(TUE) |
| | 13:00 | 16:00 | 13:00 |
| POINT | X | Y | Z |
| CON- | ORDERED | PURCHASED | ORDERED |
| TENT | PASTA | DUMPLING | PASTA |

As illustrated in Table 1, the user ordered pasta twice on weekdays. In other words, it is conceivable that the user likes to eat pasta on weekdays. Thus, as recommendation information related to pasta, a coupon ticket of a pasta restaurant is presented to the user. In this way, a usage rate of recommendation information can be increased by presenting the recommendation information that suits a preference of the user.

### Third Example Embodiment

A third example embodiment is a modification example of the first example embodiment described above. The recommendation control device 100 according to the first example embodiment extracts a behavior history that satisfies a predetermined extraction condition, based on settlement information, date and time information, and the like included in a behavior history registered in the history DB 110a. On the other hand, in the third example embodiment, a user himself/herself classifies behavior histories.

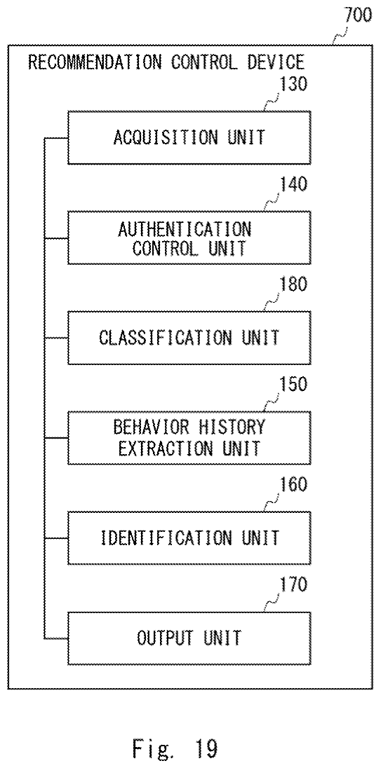

FIG. 19 is a block diagram illustrating a configuration of a recommendation control device 700 according to the third example embodiment. The recommendation control device 700 includes a classification unit 180 in addition to the configuration of the recommendation control device 100a illustrated in FIG. 3. For each configuration included in the recommendation control device 700, description overlapping the second example embodiment will be appropriately omitted.

The classification unit 180 classifies a predetermined history included in a behavior history into any of a plurality of groups, based on specification from a user. The plurality of groups are, for example, “weekday” and “weekend”, “lunch” and “dinner”, “visited alone”, “visited with co-worker”, and “visited with family”, and the like. The user specifies a classification of a predetermined history from an operation terminal such as a user terminal. The operation terminal transmits the specification of the classification to the recommendation control device 700 via a network 500. When the classification unit 180 receives the specification of the classification, the classification unit 180 classifies the predetermined history into any of the plurality of groups according to a specification content.

In the present example embodiment, a behavior history extraction unit 150 may set, as a predetermined extraction condition, classification into a predetermined group among a plurality of groups. For example, when specification of a predetermined group is received from a user, the behavior history extraction unit 150 sets, as a predetermined extraction condition, classification into the predetermined group.

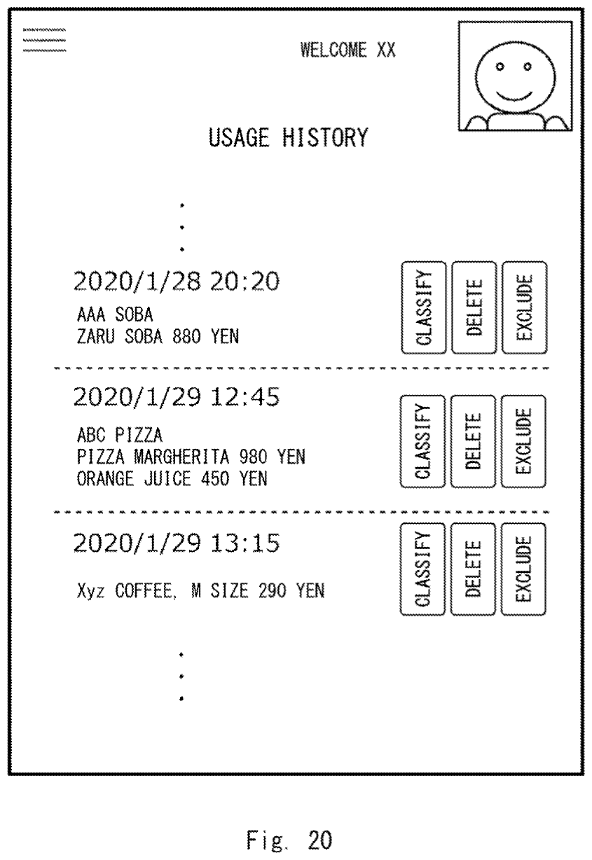

A user performs classification of each settlement history from a settlement history screen displayed on the operation terminal. FIG. 20 is a diagram illustrating a history setting screen displayed on the operation terminal. As illustrated in FIG. 20, for example, each settlement history and a button for performing processing on each settlement history are displayed on the history setting screen. The processing on each settlement history is, for example, “classify”, “delete”, and “exclude”. The user can select the button for performing the processing on each settlement history. Note that, when only each settlement history is displayed on the history setting screen, and the user selects any settlement history, a button for performing processing on the settlement history may be displayed. Note that a desire for classification of the user may be received on the history registration screen illustrated in FIG. 18.

When the user selects the exclusion button, the operation terminal transmits specification for excluding the payment history to the recommendation control device 700 via the network 500. When the behavior history extraction unit 150 receives the specification for excluding the payment history, the behavior history extraction unit 150 adds a condition for excluding the payment history to a predetermined extraction condition. When the user selects the deletion button, the operation terminal transmits specification for deleting the payment history to the recommendation control device 700 via the network 500. When a history registration unit (not illustrated) receives the specification for deleting the payment history, the history registration unit deletes the payment history from a history storage unit (not illustrated).

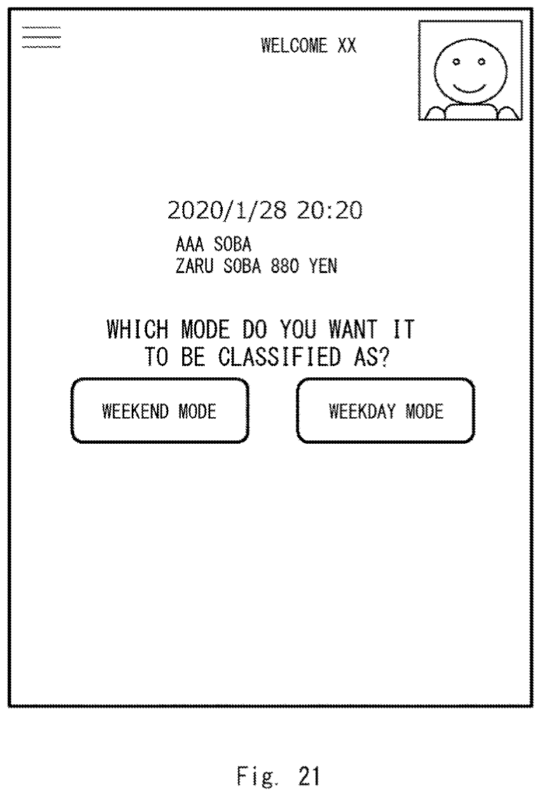

When the user selects the classification button, the operation terminal displays a history classification screen. FIG. 21 is a diagram illustrating the history classification screen displayed on the operation terminal. A button for classifying a behavior history into each group is displayed on the history classification screen. As illustrated in FIG. 21, the button for classification is, for example, “weekday mode” and “weekend mode”. The user can select the button for classifying a behavior history into each group.

When the user selects the weekday button, the operation terminal transmits specification for classifying the behavior history into a weekday group to the recommendation control device 700 via the network 500. When the user selects the weekend button, the operation terminal transmits specification for classifying the behavior history into a weekend group to the recommendation control device 700 via the network 500. When the classification unit 180 receives the specification for classifying the behavior history, the classification unit 180 classifies the behavior history into the specified group.

The recommendation control device 700 according to the present example embodiment can classify groups of behavior histories by a user himself/herself, and can thus more accurately remove noise of the behavior histories.

Furthermore, the recommendation control device according to the present example embodiment can also acquire an effect similar to the effect described in the first and second example embodiments.

### Fourth Example Embodiment

A fourth example embodiment is a modification example of the first to third example embodiments described above. The recommendation control devices 100, 100a, and 700 according to the first to third example embodiments perform face authentication by using the external authentication device 200. On the other hand, a recommendation control device 800 according to the present example embodiment performs the face authentication inside the device.

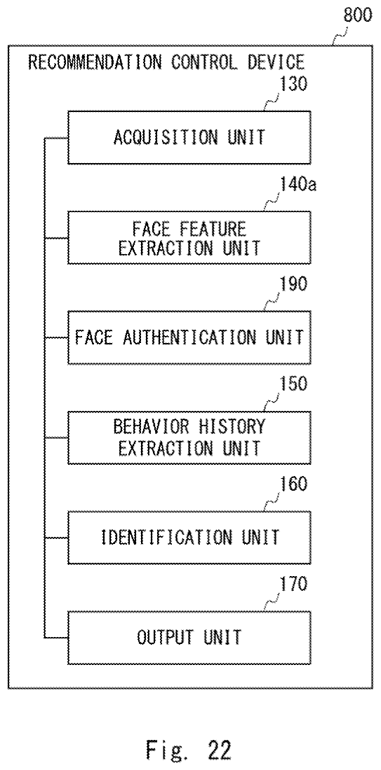

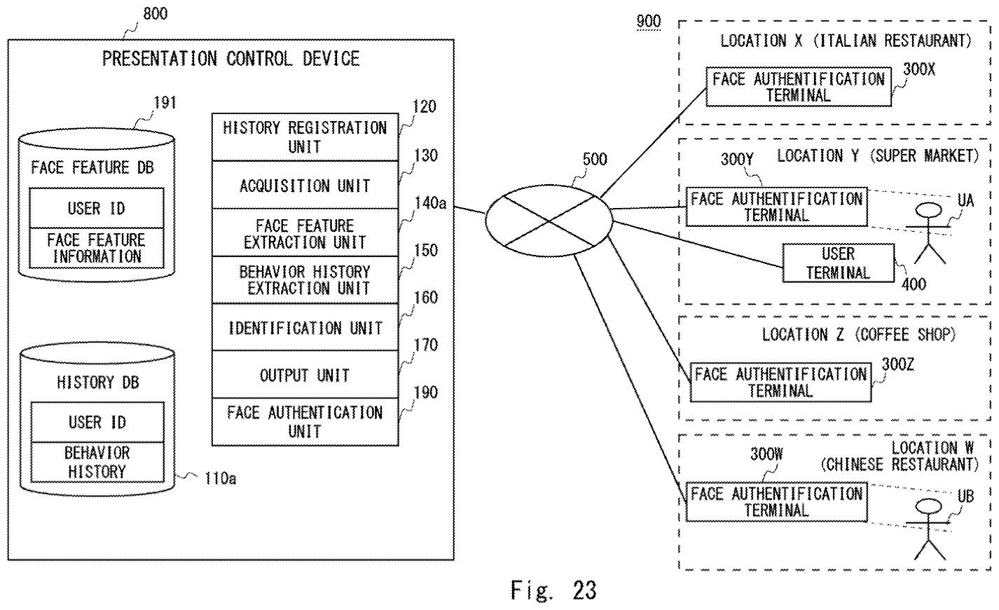

FIG. 22 is a block diagram illustrating a configuration of the recommendation control device 800 according to the fourth example embodiment. As compared to the recommendation control device 100 illustrated in FIG. 1, in the recommendation control device 800, the authentication control unit 140 is replaced with a face feature extraction unit 140a and a face authentication unit 190, and a face feature DB 191 (not illustrated) is added. Note that the face feature DB 191 is one example of a face feature information storage unit. For each configuration included in the recommendation control device 800, description overlapping the second example embodiment will be appropriately omitted. FIG. 23 is a block diagram illustrating a configuration of a recommendation control system 900 according to the fourth example embodiment. The recommendation control system 900 is different from the recommendation control system 600 in points that the recommendation control system 900 does not include the authentication device 200 and includes the recommendation control device 800. The other configuration is similar, and thus description will be appropriately omitted.

The face feature extraction unit 140a extracts a face area or face feature information from a captured image. The face authentication unit 190 performs the face authentication, based on the extracted face area or the extracted face feature information. The face feature DB 191 is a face feature database that stores a user ID and face feature information about the user in association with each other. Similarly to the recommendation control device 100, the recommendation control device 800 controls presentation of recommendation information by the flow illustrated in FIG. 2. However, in step S103, the face feature extraction unit 140a extracts a face area or face feature information from a captured image acquired by an acquisition unit 130, and the face authentication unit 190 performs the face authentication, based on the extracted face area or the extracted face feature information. Furthermore, the recommendation control device according to the present example embodiment can also acquire an effect similar to the effect described in the first to third example embodiments.

Note that the example embodiments described above have been described above as a configuration of hardware, which is not limited thereto. The present disclosure can also achieve any processing by causing a CPU to execute a computer program.

In the example described above, a program is stored by using a non-transitory computer-readable medium of various types, and can be supplied to a computer. The non-transitory computer-readable medium includes a tangible storage medium of various types. Examples of the non-transitory computer-readable medium include a magnetic recording medium (for example, a flexible disc, a magnetic tape, and a hard disc drive), a magneto-optical recording medium (for example, a magneto-optical disc), a CD-read only memory (CD-ROM), a CD-R, a CD-R/W, a digital versatile disc (DVD), and a semiconductor memory (for example, a mask ROM, a programmable ROM (PROM), an erasable PROM (EPROM), a flash ROM, and a random access memory (RAM)). Further, a program may be supplied to a computer by a transitory computer-readable medium of various types. Examples of the transitory computer-readable medium include an electric signal, an optical signal, and an electromagnetic wave. The transitory computer-readable medium can supply a program to a computer via a wired communication path such as an electric wire and an optical fiber or a wireless communication path.

Note that the present disclosure is not limited to the example embodiments described above, and may be appropriately modified without departing from the scope of the present disclosure. Further, the present disclosure may be implemented by appropriately combining the example embodiments.

A part or the whole of the above-described example embodiments may also be described as in supplementary notes below, which is not limited thereto.

### (Supplementary Note A1)

A recommendation control device comprising:

acquisition unit for acquiring a captured image being captured by a predetermined photographing device;

authentication control unit for extracting a face area or face feature information from the captured image, and causing an authentication device to perform face authentication;

behavior history extraction unit for extracting a behavior history that satisfies a predetermined extraction condition from a behavior history of a user successful in the face authentication;

identification unit for identifying recommendation information, based on a behavior history extracted by the behavior history extraction unit; and

output unit for transmitting recommendation information identified by the identification unit to a predetermined display terminal.

### (Supplementary Note A2)

The recommendation control device according to Supplementary Note A1, further comprising:

history storage unit for storing behavior histories of a plurality of users; and

history registration unit for registering a user ID and a behavior history in association with each other in the history storage unit,

wherein the behavior history extraction unit acquires, from the history storage unit, a behavior history associated with a user ID of a user successful in the face authentication, and extracts a behavior history that satisfies a predetermined extraction condition from the acquired behavior history.

### (Supplementary Note A3)

The recommendation control device according to Supplementary Note A1 or A2, wherein

the behavior history includes a plurality of settlement histories of the user,

the predetermined extraction condition includes a specific settlement history, and

the behavior history extraction unit extracts the specific settlement history from among the plurality of settlement histories.

### (Supplementary Note A4)

The recommendation control device according to Supplementary Note A3, wherein

the predetermined extraction condition further includes a predetermined time zone in which settlement is performed, and

the behavior history extraction unit extracts a settlement history in which the user performs settlement in the predetermined time zone from among the plurality of settlement histories.

### (Supplementary Note A5)

The recommendation control device according to Supplementary Note A3 or A4, wherein

the predetermined extraction condition further includes a predetermined period in which settlement is performed, and

the behavior history extraction unit extracts a settlement history in which the user performs settlement in the predetermined period from among the plurality of settlement histories.

### (Supplementary Note A6)

The recommendation control device according to any one of Supplementary Notes A3 to A5, wherein

the predetermined extraction condition further includes, as a condition, settlement being performed for a reference number of times or more in a predetermined period, and

the behavior history extraction unit extracts a settlement history in which the user performs settlement for the reference number of times or more in a predetermined period from among the plurality of settlement histories.

### (Supplementary Note A7)

The recommendation control device according to any one of Supplementary Notes A1 to A6, wherein, when the behavior history extraction unit receives specification for excluding a specific behavior history from the user, the behavior history extraction unit adds a condition for excluding the specified specific behavior history to the predetermined extraction condition.

### (Supplementary Note A8)

The recommendation control device according to any one of Supplementary Notes A1 to 7, further comprising classification unit for classifying a predetermined history included in the behavior history into any of a plurality of groups, based on specification from the user,

wherein, when the behavior history extraction unit receives specification of a predetermined group among the plurality of groups from the user, the behavior history extraction unit sets classification into the predetermined group as the predetermined extraction condition.

### (Supplementary Note A9)

The recommendation control device according to any one of Supplementary Notes A1 to A8, wherein the behavior history includes at least one of a settlement history, an enter/exit history, and a participation history of the user.

### (Supplementary Note B1)

A recommendation control system comprising:

a predetermined photographing device configured to capture an image including a face area of a user;

a recommendation control device configured to be communicable with the predetermined photographing device; and

an authentication device configured to store face feature information about the user, and be communicable with the recommendation control device,

wherein the recommendation control device includes
acquisition unit for acquiring a captured image being captured by a predetermined photographing device,
authentication control unit for extracting a face area or face feature information from the captured image, and causing an authentication device to perform face authentication,
behavior history extraction unit for extracting a behavior history that satisfies a predetermined extraction condition from a behavior history of a user successful in the face authentication,
identification unit for identifying recommendation information, based on a behavior history extracted by the behavior history extraction unit, and
output unit for transmitting recommendation information identified by the identification unit to a predetermined display terminal.

### (Supplementary Note B2)

The recommendation control system according to Supplementary Note B1, wherein

the recommendation control device further includes
history storage unit for storing behavior histories of a plurality of users, and
history registration unit for registering a user ID and a behavior history in association with each other in the history storage unit, and

the behavior history extraction unit acquires, from the history storage unit, a behavior history associated with a user ID of a user successful in the face authentication, and extracts a behavior history that satisfies a predetermined extraction condition from the acquired behavior history.

### (Supplementary Note C1)

A recommendation control method comprising,

by a computer:

a step of acquiring a captured image being captured by a predetermined photographing device;

a step of extracting a face area or face feature information from the captured image, and causing an authentication device to perform face authentication;

a step of extracting a behavior history that satisfies a predetermined extraction condition from a behavior history of a user successful in the face authentication;

a step of identifying recommendation information, based on the extracted behavior history; and

a step of transmitting the identified recommendation information to a predetermined display terminal.

### (Supplementary Note D1)

A non-transitory computer-readable medium configured to store a recommendation control program causing a computer to execute:

a step of acquiring a captured image being captured by a predetermined photographing device;

a step of extracting a face area or face feature information from the captured image, and causing an authentication device to perform face authentication;

a step of extracting a behavior history that satisfies a predetermined extraction condition from a behavior history of a user successful in the face authentication;

a step of identifying recommendation information, based on the extracted behavior history; and

a step of transmitting the identified recommendation information to a predetermined display terminal.

### (Supplementary Note E1)

A recommendation control device comprising:

acquisition unit for acquiring a captured image being captured by a predetermined photographing device;

face feature extraction unit for extracting a face area or face feature information from the captured image;

face authentication unit for performing face authentication, based on the face area or the face feature information;

behavior history extraction unit for extracting a behavior history that satisfies a predetermined extraction condition from a behavior history of a user successful in the face authentication;

identification unit for identifying recommendation information, based on a behavior history extracted by the behavior history extraction unit; and

output unit for transmitting recommendation information identified by the identification unit to a predetermined display terminal.

### (Supplementary Note E2)

The recommendation control device according to Supplementary Note E1, further comprising:

history storage unit for storing behavior histories of a plurality of users; and

history registration unit for registering a user ID and a behavior history in association with each other in the history storage unit,

wherein the behavior history extraction unit acquires, from the history storage unit, a behavior history associated with a user ID of a user successful in the face authentication, and extracts a behavior history that satisfies a predetermined extraction condition from the acquired behavior history.

### (Supplementary Note F1)

A recommendation control method comprising,

by a computer:

a step of acquiring a captured image being captured by a predetermined photographing device;

a step of extracting a face area or face feature information from the captured image;

a step of performing face authentication, based on the face area or the face feature information;

a step of extracting a behavior history that satisfies a predetermined extraction condition from a behavior history of a user successful in the face authentication;

a step of identifying recommendation information, based on the extracted behavior history; and

a step of transmitting the identified recommendation information to a predetermined display terminal.

### (Supplementary Note G1)

A non-transitory computer-readable medium configured to store a recommendation control program causing a computer to execute:

a step of acquiring a captured image being captured by a predetermined photographing device;

a step of extracting a face area or face feature information from the captured image;

a step of performing face authentication, based on the face area or the face feature information;

a step of extracting a behavior history that satisfies a predetermined extraction condition from a behavior history of a user successful in the face authentication;

a step of identifying recommendation information, based on the extracted behavior history; and

a step of transmitting the identified recommendation information to a predetermined display terminal.

The invention of the present application is described above with reference to the example embodiments (examples), but the invention of the present application is not limited to the example embodiments (examples) described above. Various modifications that can be understood by those skilled in the art can be made to the configuration and the details of the invention of the present application within the scope of the invention of the present application.

### REFERENCE SIGNS LIST

100, 100a, 700, 800 RECOMMENDATION CONTROL DEVICE
600, 900 RECOMMENDATION CONTROL SYSTEM
110a HISTORY DB
120 HISTORY REGISTRATION UNIT
130 ACQUISITION UNIT
140 AUTHENTICATION CONTROL UNIT
140a FACE FEATURE EXTRACTION UNIT
150 BEHAVIOR HISTORY EXTRACTION UNIT
160 IDENTIFICATION UNIT
170 OUTPUT UNIT
180 CLASSIFICATION UNIT
190 FACE AUTHENTICATION UNIT
191 FACE FEATURE DB
200 AUTHENTICATION DEVICE
210 FACE FEATURE DB
220 FACE DETECTION UNIT
230 FEATURE POINT EXTRACTION UNIT
240 REGISTRATION UNIT
250 AUTHENTICATION UNIT
300 (300X TO 300W) FACE AUTHENTICATION TERMINAL
310 CAMERA
320 CONTROL UNIT
322 PHOTOGRAPHING REQUEST UNIT
323 FACE FEATURE INFORMATION REGISTRATION-REQUEST UNIT
324 AUTHENTICATION REQUEST UNIT
325 SETTLEMENT PROCESSING UNIT
326 HISTORY REGISTRATION REQUEST UNIT
327 RECOMMENDATION REQUEST UNIT
330 STORAGE UNIT
340 COMMUNICATION UNIT
350 DISPLAY UNIT
400 USER TERMINAL
410 CAMERA
420 CONTROL UNIT
422 PHOTOGRAPHING REQUEST UNIT
423 FACE FEATURE INFORMATION REGISTRATION-REQUEST UNIT
424 AUTHENTICATION REQUEST UNIT
425 SETTLEMENT PROCESSING UNIT
426 HISTORY REGISTRATION REQUEST UNIT
427 RECOMMENDATION REQUEST UNIT
430 STORAGE UNIT
440 COMMUNICATION UNIT
450 DISPLAY UNIT
500 NETWORK

What is claimed is:

1. A recommendation control device comprising:
at least one memory acquiring storing instructions and
at least one processor configured to execute the instructions to;
acquire a captured image being captured by a predetermined photographing device;
extract a face area or face feature information from the captured image, and causing an authentication device to perform face authentication;
extract a behavior history that satisfies a predetermined extraction condition from a behavior history of a user successful in the face authentication;
identify recommendation information, based on a behavior history; and
transmit recommendation information to a predetermined display terminal.

2. The recommendation control device according to claim 1, wherein the at least one memory is configured to store behavior histories of a plurality of users; and
the at least one processor is further configured to execute the instructions to:
resister a user ID and a behavior history in association with each other in the at least one memory,
acquire, from the at least one memory, a behavior history associated with a user ID of a user successful in the face authentication, and extracts a behavior history that satisfies a predetermined extraction condition from the acquired behavior history.

3. The recommendation control device according to claim 1, wherein
the behavior history includes a plurality of settlement histories of the user,
the predetermined extraction condition includes a specific settlement history, and
the at least one processor is further configured to execute the instructions to:
extract the specific settlement history from among the plurality of settlement histories.

4. The recommendation control device according to claim 3, wherein
the predetermined extraction condition further includes a predetermined time zone in which settlement is performed, and
the at least one processor is further configured to execute the instructions to:
extract a settlement history in which the user performs settlement in the predetermined time zone from among the plurality of settlement histories.

5. The recommendation control device according to claim 3, wherein
the predetermined extraction condition further includes a predetermined period in which settlement is performed, and
the at least one processor is further configured to execute the instructions to:
extract a settlement history in which the user performs settlement in the predetermined period from among the plurality of settlement histories.

6. The recommendation control device according to claim 3, wherein
the predetermined extraction condition further includes, as a condition, settlement being performed for a reference number of times or more in a predetermined period, and
the at least one processor is further configured to execute the instructions to:
extract a settlement history in which the user performs settlement for the reference number of times or more in a predetermined period from among the plurality of settlement histories.

7. The recommendation control device according to claim 1, wherein, when the at least one processor receives specification for excluding a specific behavior history from the user, the at least one processor is further configured to execute the instructions to adds a condition for excluding the specified specific behavior history to the predetermined extraction condition.

8. The recommendation control device according to claim 1, the at least one processor is further configured to execute the instructions to classify a predetermined history included in the behavior history into any of a plurality of groups, based on specification from the user,
wherein, when the at least one processor receives specification of a predetermined group among the plurality of groups from the user, the at least one processor is further configured to execute the instructions to set classification into the predetermined group as the predetermined extraction condition.

9. The recommendation control device according to claim 1, wherein the behavior history includes at least one of a settlement history, an enter/exit history, and a participation history of the user.

10. A recommendation control system comprising:
a predetermined photographing device configured to capture an image including a face area of a user;
a recommendation control device configured to be communicable with the predetermined photographing device; and
an authentication device configured to store face feature information about the user, and be communicable with the recommendation control device,
wherein the recommendation control device includes
acquisition means for acquiring a captured image being captured by a predetermined photographing device,
authentication control means for extracting a face area or face feature information from the captured image, and causing an authentication device to perform face authentication,
behavior history extraction means for extracting a behavior history that satisfies a predetermined extraction condition from a behavior history of a user successful in the face authentication,
identification means for identifying recommendation information, based on a behavior history extracted by the behavior history extraction means, and
output means for transmitting recommendation information identified by the identification means to a predetermined display terminal.

11. The recommendation control system according to claim 10, wherein
the recommendation control device further includes
history storage means for storing behavior histories of a plurality of users, and
history registration means for registering a user ID and a behavior history in association with each other in the history storage means, and
the behavior history extraction means acquires, from the history storage means, a behavior history associated with a user ID of a user successful in the face authentication, and extracts a behavior history that satisfies a predetermined extraction condition from the acquired behavior history.

12. A recommendation control method comprising,
by a computer:
a step of acquiring a captured image being captured by a predetermined photographing device;
a step of extracting a face area or face feature information from the captured image, and causing an authentication device to perform face authentication;
a step of extracting a behavior history that satisfies a predetermined extraction condition from a behavior history of a user successful in the face authentication;
a step of identifying recommendation information, based on the extracted behavior history; and
a step of transmitting the identified recommendation information to a predetermined display terminal.

13. A non-transitory computer-readable medium configured to store a recommendation control program causing a computer to execute:
a step of acquiring a captured image being captured by a predetermined photographing device;
a step of extracting a face area or face feature information from the captured image, and causing an authentication device to perform face authentication;
a step of extracting a behavior history that satisfies a predetermined extraction condition from a behavior history of a user successful in the face authentication;
a step of identifying recommendation information, based on the extracted behavior history; and
a step of transmitting the identified recommendation information to a predetermined display terminal.

14. A recommendation control device comprising:
at least one memory acquiring storing instructions and
at least one processor configured to execute the instructions to;
acquire a captured image being captured by a predetermined photographing device;
extract a face area or face feature information from the captured image;
perform face authentication, based on the face area or the face feature information;
extract a behavior history that satisfies a predetermined extraction condition from a behavior history of a user successful in the face authentication;
identify recommendation information, based on a behavior history; and
transmit recommendation information to a predetermined display terminal.

15. The recommendation control device according to claim 14, wherein the at least one memory is configured to store behavior histories of a plurality of users; and
the at least one processor is further configured to execute the instructions to:
resister a user ID and a behavior history in association with each other in the at least one memory,
acquire, from the at least one memory, a behavior history associated with a user ID of a user successful in the face authentication, and extracts a behavior history that satisfies a predetermined extraction condition from the acquired behavior history.

16. A recommendation control method comprising,
by a computer:
a step of acquiring a captured image being captured by a predetermined photographing device;
a step of extracting a face area or face feature information from the captured image;
a step of performing face authentication, based on the face area or the face feature information;
a step of extracting a behavior history that satisfies a predetermined extraction condition from a behavior history of a user successful in the face authentication;
a step of identifying recommendation information, based on the extracted behavior history; and
a step of transmitting the identified recommendation information to a predetermined display terminal.

17. A non-transitory computer-readable medium configured to store a recommendation control program causing a computer to execute:
a step of acquiring a captured image being captured by a predetermined photographing device;
a step of extracting a face area or face feature information from the captured image;
a step of performing face authentication, based on the face area or the face feature information;
a step of extracting a behavior history that satisfies a predetermined extraction condition from a behavior history of a user successful in the face authentication;
a step of identifying recommendation information, based on the extracted behavior history; and
a step of transmitting the identified recommendation information to a predetermined display terminal.
